(19) United States
(12) Patent Application Publication
(10) Pub. No.: US 2008/0284977 A1
(43) Pub. Date: Nov. 20, 2008

(54) Progressive Multi-Focal Lens

(75) Inventor: Jackson Che-Shang Huang, Suzhou (CN)

Correspondence Address: Jackson Che-Shang;Caihong New Village, 901-902 Sanxiang Road, Suzhou, 215004, CN

(73) Assignee: Suzhou Good Star Optical Co., Ltd., Suzhou (CN)

(21) Appl. No.: 11/756,888

(22) Filed: Jun. 1, 2007

(30) Foreign Application Priority Data
May 15, 2007 (CN) 200720154680.8

(51) Int. Cl. G02C 7/06

(52) U.S. Cl. 351/169

(57) ABSTRACT

A kind of wide visual field mediate to near distances progressive multi-focal lens, it belongs to spectacle or same spectacle's characteristic protective lens, which consists of near and intermediate visual areas, the described lens has progressive surfaces which designed gradually step by step with different diopters in the mediate intermediate and near visual areas.

The narrowest visual corridor (path) has width 18-20 mm, the described lens from central line down to near visual area has length 10 mm. This lens has wider visual corridor in the intermediate area, also has six focci are reasonable located in the corridor, will affect to improve vision of wearer for the visual fields, increase up the degree of width and clarity, of vision also strengthen the comfortable feelings when wore the spectacle; in addition, it will affect to delete the damage of vision by current market lens which made and caused by incorrect eye's examination. This lens is used for corrective presbyopia vision, specially corrective for mediate and near distance presbyopia vision.

A kind of wide visual field mediate to near distances progressive multi-focal lens.

### FIELD OF THE TECHNOLOGY

This art is belonging to spectacles, and which protective and corrective lenses have the same characteristics. Practically it concerns to a kind of progressive multi-focal lens which has wider visual field on medicate and near distances. Its combination of optical design and visual physiology will and create the comfortable effecting of vision.

### BACKGROUND OF TECHNOLOGY OF ART

When the medium and old peoples who are entering to the ages over 40, the problem of their visual conditions are not able to avoid due to physiological phenomenon, single vision reading and Bifocal lenses etc eyeglasses which marked “old vision” looks are refused to wear by most of presbyopia peoples due to cosmetic and psychological reasons. On the other hand, single power (Diopter) of lens has only one focus to see one focal length, how to remain wearing spectacle nor only use for reading, writing, in addition, use it for looking the deferent distances of environment, apply a progressive multi-focal lens as corrective presmyopia vision become the most important series of matters.

The characteristics of progressive multi-focal lens is: There is continuously changed dioptric power in the intermediate area between a area fixed Far Vision—Distance in the lens upper area and a fixed near vision distance in the lens lower area. In those areas, pass lens radices converts gradually to smaller rate and let the lens dipodic power gradually increase up. The spectacle wearer can eliminate the trouble of take on or off the reading glasses all the time; also can well-seeing the object by means of different distances to arrange reasonable focus; achieve the adjustment for far, and near visual distances; but a progressive multi-focal lens it main characteristics and dates are correlated, influenced each other, which includes the sizes of far visual and near visual areas, the length of progressive and width of visual effective area, it should remain certain degrees of coordination and project of intermediate treatment between the useful areas and distortion cylindrical areas. Distortion cylindrical forms a difficult overcomes and main problems in progressive lens. Although a correct prescription is able to give clear vision on the area of progressive area, but beside of this area will come object with obtain degree of distortion, the degree and direction of distortion will depend on the different sign the low and high powers of addition, it will be obviously the distortion of resolution when eyes move from available progressive central area is more far away distance.

By the mean of application on CNC Leth cut machine, Essilor, Sola and Carl-Zeiss etc famous lens factories, they all have designed many kinds of multi-focal lenses to serve those patients who need to wear presbyopia eyeglasses, example as photo picture 1 (see drawing), and photo picture 2, this kind of progressive multi-focal lens consists of far visual area 1. Near visual area 3, intermediate visual area 2 and distortion blurry area 4; lowest diopter is in far visual area located in the top of lens, highest diopter is in near visual area located in the bottom of lens, far visual area to the bottom diopters are gradually increasing up, intermediate visual area is located between far visual area and near visual area, its diopters are gradually increasing to the bottom. Distortion blurry area is located two sides of intermediate area. Usually the marketing progressive lens has visual corridor in length of 23-24 mm, and width of intermediate area is 6-7 mm, central line down to near visual area, central point is 14 mm of progressive lens multi-focal are concentrated in vertical direction and spread in this visual corridor (14 mm), so that dioptrically powers are easily caused vibration in this area, because of visual corridor is too narrow (6-7 mm) in this area, when vision goes pass through this area, it will cause uncomfortable feelings, further more, uncomforted distortion of object accident injured by fall down during walking and goes up and down the stairs will be happened due to two sides of the area are too much closed to the vision blurry area.

### DETAILED DESCRIPTION OF THE ART

The main purpose of this new art id providing a kind of optical design perfectly, it has more wider visual field in the intermediate area, also it is a combination of vision optics and physiology which create the comfortable vision affect as a mediate to near distances wide visual field progressive multi-focal lens. It dissolves problem of narrow intermediate area of current progressive lens in the market, which has un-reasonable problems of easily create visual distortion also un-reasonable problem in the locations of muli-focci.

To achieve of practice above purpose of invention, this new art applying the programs of technology as below:

A kind of wide visual field progressive multi-focal lens, consists of near and intermediate visual areas, this special described lens, its surface has structured different diopters in the mediate, intermediate and near visual areas, narrowest visual corridor is 18-20 mm in the intermediate area, the length of described lens central line down to near visual area is 10 mm.

Description in precision this progressive multi-focal lens described near distance area, its visual corridor is 24 mm.

Described mediate distance, intermediate and near distance of areas, has structured six focci which from far gradually enter to near visual area all focci are located in the field of 10 mm up and 10 mm down central line.

Described Number 1 focus as mediated visual distance visual area. Number 2 focus is located 2 mm up central line; Number 3 focus is located 2 mm down central line: Number 4 focus is located 4 mm down central line: Number 5 focus is located 7 mm down central line; Number 6 focus is located 10 mm down central line.

Described Number 2 focus and Number 3 focus have width of visual corridor 18-20 mm, described Number 5 focus and Number 6 focus have width of visual corridor 24 mm.

Described six focci, which diopters have changed and increased equally step by step, from top to the bottom, increased rate is 0.25 D (Diopter). Described intermediate area, its two sides have been strutted with soft blurry areas, which spread evenly and these two sides nearest distance is 18-20 mm.

Described lens is a structure made from optical resin or polycarbonate optical grade materials, it is also a lens which form multi-focci gradually in the lens.

Applying precise CNC lath-cut equipment, design the precise figures of progressive foci which are forming whole multi-focal areas located in a concave surface of glass mold or steel mold, use optical resin or polycarbonate optical grade materials which solidify and forming described multi-focal lens from casting and compression molding methods.

Described wide visual field mediate to near distances progressive multi-focal lens has width of intermediate corridor over 18 mm which is three times of current market product in the same area corridor, vision may goes pass three focci in the intermediate area to see wide and comfortable objects, avoid the distortion when goes pass narrow corridor of intermediate area. On human's eyes with lens mounted in the frame, in fact, we can figure average usage on frequencies, also figure usual visual distances by an idea structure of design, the reasonable participation of six focci, will delete tremendously uncomforted feeling due to the increase of progressive powers, people can do comfortable on reading (0.3˜0.6 mm), operating computer, watching TV or talking with friends (0.5˜2.0 mm). Attending a conference (2.0˜2.5 mm), clear to see objects mediate distances (2.5˜4.0 mm) indoor and outdoor. Described lens'Number 5 and Number 6 focci has an width over 24 mm in the visual corridor, it's focal lengths are shorter down the central line, so that, it will be able to see clear on whole visual fields when do regular reading, writing, operating computer, reading newspaper, it has no need to rise up head and no need to move down eyes, a clear and comfort of visions will be appeared.

Described new art has affective advantages of the wider visual field in the intermediate visual corridor and structure with six focci reasonable participated in the progressive multi-focal lens, which will improve the visual affective fields for the spectacle wearer, increase width and clarity of vision, strength comfort-feelings of an wearer, affective delete damages of vision due to un-reasonable eye testing and prescription of presbyopia, especially for correction of presbyopia in mediate and near distances.

### DESCRIPTIONS OF FIGURES

The following combination of figures and examples for more detailed description on this new art.

FIG. 1 is shown the visual area and corridor of current market's progressive lens.

FIG. 2 is shown participation of focci and mediate visual area as FIG. 1.

FIG. 3 is shown visual area and corridor in described new art.

FIG. 4 is shown participation of focci and mediate visual area as FIG. 3.

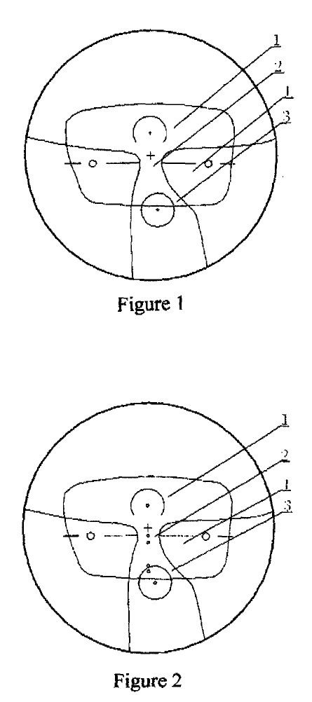

### EXAMPLES

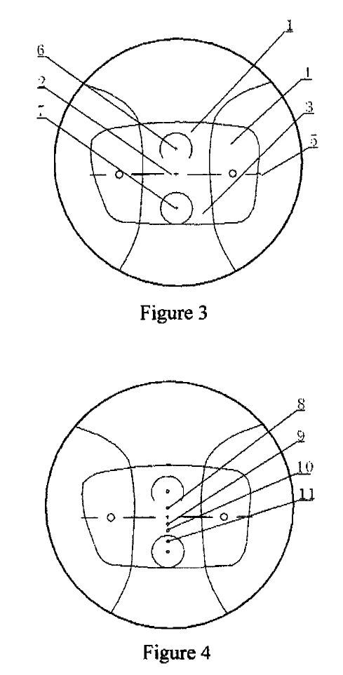

As FIG. 3 and FIG. 4, described wide visual field mediate to near distances progressive multi-focal lens, which is made from optical resin or polycarbonate materials, consists of mediate visual area 1 near visual area 3, intermediate area 2 and located in the two side of soft blurred areas 4, in these areas, different Dioptric powers are forming gradually go through mediate visual area, intermediate area and near visual area in the surface of described lens; the narrowest width of visual corridor is 18 mm in the intermediate area; and two sides of soft blurred area are equally located, it's nearest of distance in two sides id 18 mm.

Described lens has field from measurement central line up 10 mm to lens central line 5 down 10 mm as mediate visual area, intermediate area and near visual area lens' structure with six focci which gradually go pass from far to near visual distances. These focci are participated as below:

The first focus 6 located in the top of mediate visual area as mediate visual distance; the second focus 8 located in the central line up 2 mm, the third focus 9 located in the central line down 2 mm, the forth focus 10 located in the central line down 4 mm, the fifth focus 11 located in the central line down 7 mm, the sixth focus 7 located in the central line down 10 mm. The dioptric powers of next focus in six focci are changed and increased gradually from top to bottom, the degree of increase is +0.25 D. The width of visual corridor in the second focus and the third focus is 18 mm, the width of visual corridor in the fifth focus and the sixth focus is 24 mm.

For example, of a middle age people who starting to wear presbyopia reading glasses, starting point of vision 0.00 D (Plano lens) is located in the central line up 10 mm, which position is just good for a human eyes look straight sight and see mediate up to far distances, it goes down 8 mm is the second focus of +0.25 D which is able to see focal length 2.5-1.0 meters, central line down 2 mm is the third focus +0.50 D, which is able to see focal length 2.0-2.5 meters, central line down 4 mm is the forth focus of 0.75 D, which is able to see focal length 1.0-2.0 meters, central line down 7 mm is the fifth focus of +1.00 D which is able to see focal length 0.5-1.0 meter, central line down 10 mm is the sixth focus of +1.25 D which is able to see focal length 0.3-0.5 meter.

1. A kind of wide visual progressive multi-focal lens for mediate and near distances, consists of mediate, near and intermediate visual areas, it specially has progressive surfaces which gradually step by step designed different diopters in the mediate intermediate and near visual areas, the narrowest visual corridor has width 18-22 mm in the intermediate visual area, the lens from measurement central line to near visual area has length 10 mm.

2. As claim 1 described a kind of wide visual field mediate to near distances progressive multi-focal lens, it has specially visual corridor width minimum 24 mm in the near visual area.

3. As claim 1 described a kind of wide visual field mediate to near distances progressive multi-focal lens, it specially has six focci are reasonable located gradually step by step from far to near in the medicate, intermediate and near visual areas. The focci are located in the field from lens central line up 10 mm to central line down 10 mm.

4. As claim 3 described a kind of wide visual field mediate and near distances progressive multi-focal lens, it specially has number one (#1) focus located the top of mediate visual area so mediate focal length, number two (#2) focus located up 2 mm of the central line; number three (#3) focus located down 2 mm of the central line; number four (#4) focus located down 4 mm of the central line; number five (#5) located down 7 mm of the central line; number six (#6) located down 10 mm of the central line.

5. As claim 3 described a kind of wide visual field mediate to near distances progressive multi-focal lens, it specially has six focci which diopters are changed and increased step by step from top to the bottom equally and gradually, it's increased degree is 0.25 D (Diopter).

6. As claim 4 described a kind of wide visual field mediate to near distances progressive multi-focal lens, it specially has width 18-20 mm of visual corridor in the areas located #1 to #2 focci places, and width 24 mm of visual corridor in the areas located #5 to # 6 focci places.

7. As claim 1 described a kind of wide visual field mediate to near distances progressive multi-focal lens, it specially has soft blurry areas between two sides of intermediate areas, these soft blurry areas are located equally part on both, the nearest distance are 18 to 20 mm between two sides.

8. As claim 1 described a kind of wide visual field mediate to near distances progressive multi-focal lens, this lens specially structure are from optical degree of resin or polycarbonate materials, also formiuy progressive multi focci in the lens.
